(19) United States
(12) Patent Application Publication
(10) Pub. No.: US 2013/0002859 A1
(43) Pub. Date: Jan. 3, 2013

(54) INFORMATION ACQUIRING DEVICE AND OBJECT DETECTING DEVICE

(75) Inventors: Atsushi YAMAGUCHI, Ibi-gun (JP); Nobuo Iwatsuki, Anpachi-gun (JP); Katsumi Umeda, Niwa-gun (JP)

(73) Assignee: Sanyo Electric Co., Ltd., Moriguchi-shi (JP)

(21) Appl. No.: 13/614,825

(22) Filed: Sep. 13, 2012

Related U.S. Application Data
(63) Continuation of application No. PCT/JP2012/059446, filed on Apr. 6, 2012.

(30) Foreign Application Priority Data
Apr. 19, 2011 (JP) 2011-092927

(51) Int. Cl. H04N 7/18

(52) U.S. Cl. 348/135; 348/E07.085

(57) ABSTRACT

Laser light emitted from a laser light source is converted into light having a dot pattern by a projection optical system for projection onto a target area. The projection optical system is configured such that the density of dots in a peripheral portion of the dot pattern is smaller than that in a center portion of the dot pattern in the target area. A dot pattern captured by irradiating a dot pattern onto a reference plane is divided into segment areas. A distance to each segment area is acquired by matching between dots in each segment area, and a dot pattern acquired by capturing an image of the target area at the time of distance measurement. The segment areas are set such that a segment area in the peripheral portion of the dot pattern is larger than a segment area in the center portion of the dot pattern.

This application claims priority under 35 U.S.C. Section 119 of Japanese Patent Application No. 2011-92927 filed on Apr. 19, 2011, entitled “INFORMATION ACQUIRING DEVICE AND OBJECT DETECTING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to irradiate a target area with laser light having a predetermined dot pattern is operable to receive reflected light of laser light having a dot pattern from the target area by a light receiving element. Then, a distance to each portion of an object to be detected (an irradiation position of each dot on an object to be detected) is detected, based on a light receiving position of each dot on the light receiving element, using a triangulation method (see e.g. pp. 1279-1280, the 19th Annual Conference Proceedings (Sep. 18-20, 2001) by the Robotics Society of Japan).

In the object detecting device thus constructed, laser light having a dot pattern is generated by diffracting laser light emitted from a laser light source by a diffractive optical element. In this arrangement, the diffractive optical element is so designed that the dot pattern on a target area is uniformly distributed with the same luminance. However, the luminance of dots in a peripheral portion of the target area may be small, as compared with the luminance of dots in a center portion of the target area, resulting from e.g. molding error of the diffractive optical element. In such a case, it is desirable to lower the density of dots in the peripheral portion and increase the luminance of dots in the peripheral portion. This arrangement, however, may degrade distance detection precision in the peripheral portion.

### SUMMARY OF THE INVENTION

A first aspect of the invention is directed to an information acquiring device for acquiring information on a target area using light. The information acquiring device according to the first aspect includes a projection optical system which projects laser light onto the target area with a predetermined dot pattern; a light receiving optical system which is aligned with the projection optical system away from the projection optical system by a predetermined distance, and captures an image of the target area, and a distance acquiring section which acquires a distance to each portion of an object in the target area, based on the dot pattern captured by the light receiving optical system. In this arrangement, the projection optical system is configured in such a manner that a density of dots in a peripheral portion of the dot pattern is smaller than a density of dots in a center portion of the dot pattern in the target area. The distance acquiring section sets segment areas onto a reference dot pattern reflected on a reference plane and captured by the light receiving optical system, and performs a matching operation between a captured dot pattern obtained by capturing the image of the target area at a time of distance measurement, and dots in each segment area to thereby acquire a distance to the each segment area. The segment areas are set in such a manner that a segment area in a peripheral portion of the reference dot pattern is larger than a segment area in a center portion of the reference dot pattern.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIGS. 4A and 4B are diagrams schematically showing a reference template generating method in the embodiment.

FIGS. 5A through 5C are diagrams for describing a method for detecting a shift position of a segment area of a reference template at the time of actual measurement in the embodiment.

FIG. 6 is a perspective view showing an installation state of a projection optical system and a light receiving optical system in the embodiment.

FIG. 7 is a diagram schematically showing an arrangement of the projection optical system and the light receiving optical system in the embodiment.

FIGS. 8A and 8B are diagrams respectively and schematically showing a measurement result indicating a luminance distribution on a CMOS image sensor, and the luminance distribution in a comparative example of the embodiment.

FIGS. 9A through 9C are diagrams schematically showing a dot distribution state in a target area in the embodiment.

FIGS. 10A and 10B are diagrams for describing a method for reducing the density of dots in a peripheral portion in the embodiment.

FIGS. 11A and 11B are diagrams respectively showing a segment area in a center portion and a segment area in a peripheral portion in the embodiment.

FIGS. 12A through 12C are diagrams schematically showing the dimensions of segment areas to be set with respect to a reference pattern area in the embodiment.

FIGS. 13A and 13B are flowcharts respectively showing a dot pattern setting processing with respect to a segment area, and a distance detection processing to be performed at the time of actual measurement in the embodiment.

FIGS. 14A through 14D are diagrams schematically showing modification examples of a dot distribution state in a target area in the embodiment.

FIGS. 15A through 15D are diagrams schematically showing modification examples on the dimensions of segment areas to be set with respect to a reference pattern area in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is exemplified an information acquiring device for irradiating a target area with laser light having a predetermined dot pattern.

In the embodiment, a CPU 21 (a three-dimensional distance calculator 21b) and an image signal processing circuit 23 correspond to a “distance acquiring section” in the claims. A DOE 114 corresponds to a “diffractive optical element” in the claims. An imaging lens 122 corresponds to a “condensing lens” in the claims. A CMOS image sensor 123 corresponds to an “image sensor” in the claims. The description regarding the correspondence between the claims and the embodiment is merely an example, and the claims are not limited by the description of the embodiment.

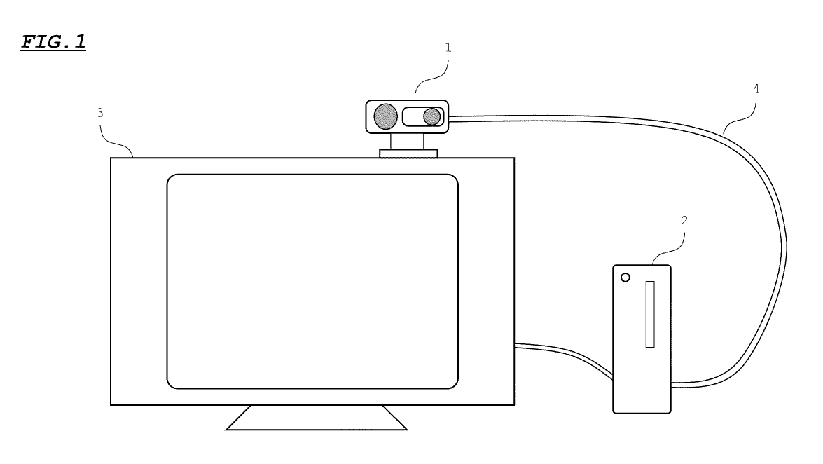

A schematic arrangement of an object detecting device according to the first embodiment is described. As shown in FIG. 1, the object detecting device is provided with an information acquiring device 1, and an information processing device 2. A TV 3 is controlled by a signal from the information processing device 2. A device constituted of the information acquiring device 1 and the information processing device 2 corresponds to an object detecting device of the invention.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

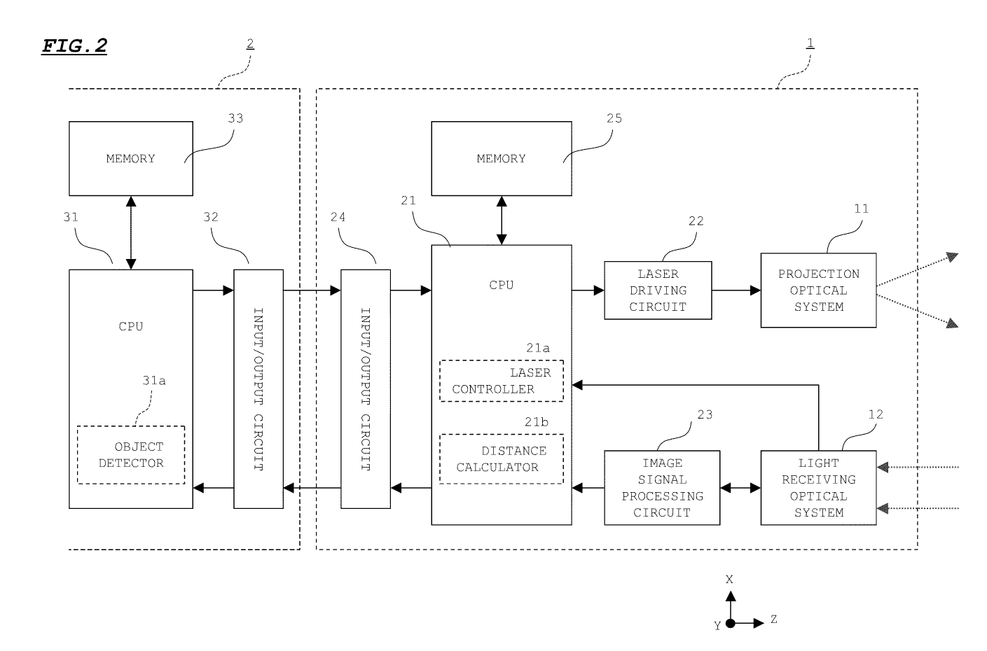

FIG. 2 is a diagram showing an arrangement of the information acquiring device 1 and the information processing device 2.

The information acquiring device 1 is provided with a projection optical system 11 and a light receiving optical system 12, which constitute an optical section. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

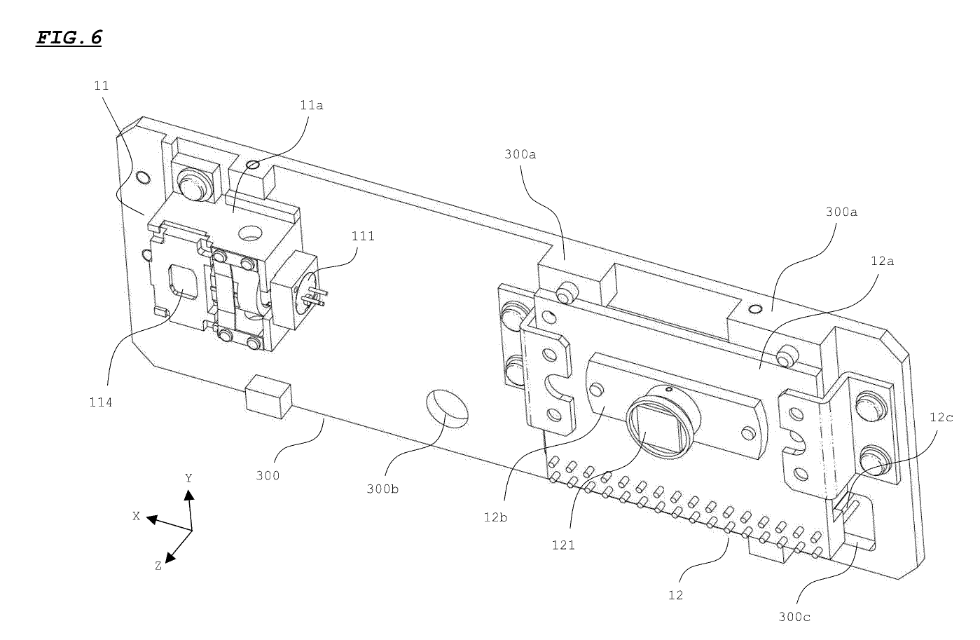

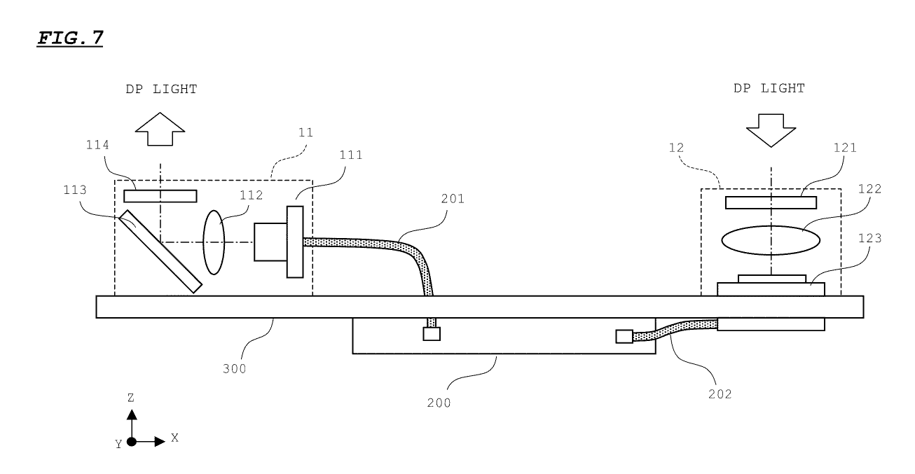

The projection optical system 11 irradiates a target area with laser light having a predetermined dot pattern. The light receiving optical system 12 receives laser light reflected on the target area. The arrangement of the projection optical system 11 and the light receiving optical system 12 will be described later referring to FIGS. 6 and 7.

The CPU 21 controls the parts of the information acquiring device 1 in accordance with a control program stored in the memory 25. By the control program, the CPU 21 has functions of a laser controller 21a for controlling the laser light source 111 (to be described later) in the projection optical system and a three-dimensional distance calculator 21b for generating three-dimensional distance information.

The laser driving circuit 22 drives the laser light source 111 (to be described later) in accordance with a control signal from the CPU 21. The image signal processing circuit 23 controls the CMOS image sensor 123 (to be described later) in the light receiving optical system 12 to successively read signals (electric charges) from the pixels, which have been generated in the CMOS image sensor 123, line by line. Then, the image signal processing circuit 23 outputs the read signals successively to the CPU 21.

The CPU 21 calculates a distance from the information acquiring device 1 to each portion of an object to be detected, by a processing to be implemented by the three-dimensional distance calculator 21b, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

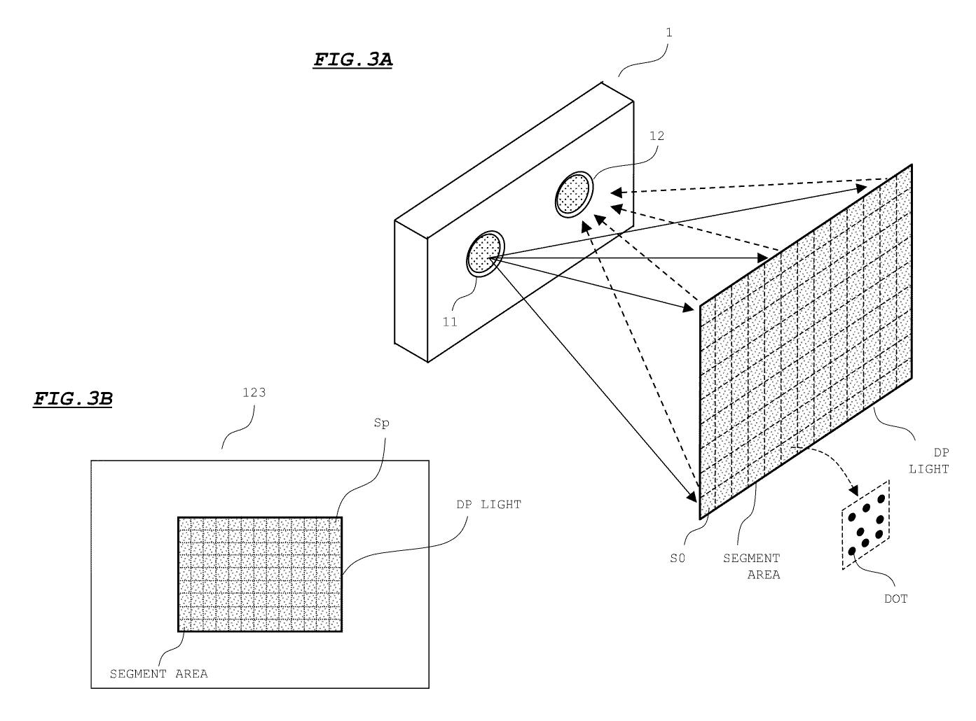

FIG. 3A is a diagram schematically showing an irradiation state of laser light onto a target area. FIG. 3B is a diagram schematically showing a light receiving state of laser light on the CMOS image sensor 123. To simplify the description, FIG. 3B shows a light receiving state in the case where a flat plane (screen) is disposed on a target area.

As shown in FIG. 3A, the projection optical system 11 irradiates laser light having a dot pattern (hereinafter, the entirety of the laser light having the dot pattern is called as “DP light”) toward a target area. FIG. 3A shows a projection area of DP light by a solid-line frame. In the light flux of DP light, dot areas (hereinafter, simply called as “dots”) in which the intensity of laser light is increased by a diffractive action of the diffractive optical element locally appear in accordance with the dot pattern by the diffractive action of the DOE 114.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 123, as shown in FIG. 3B. For instance, light of a segment area S0 in the target area shown in FIG. 3A is entered to a segment area Sp shown in FIG. 3B, on the CMOS image sensor 123. In FIG. 3B, a light flux area of DP light is also indicated by a solid-line frame, and to simplify the description, a light flux of DP light is divided into segment areas arranged in the form of a matrix in the same manner as shown in FIG. 3A.

The three-dimensional distance calculator 21b is operable to perform detection (hereinafter, called as “pattern matching”) at which position on the CMOS image sensor 123, light of each segment area is entered, for detecting a distance to each portion of an object to be detected (an irradiation position of each segment area), based on a light receiving position on the CMOS image sensor 123, using a triangulation method. The details of the above detection method is disclosed in e.g. pp. 1279-1280, the 19th Annual Conference Proceedings (Sep. 18-20, 2001) by the Robotics Society of Japan.

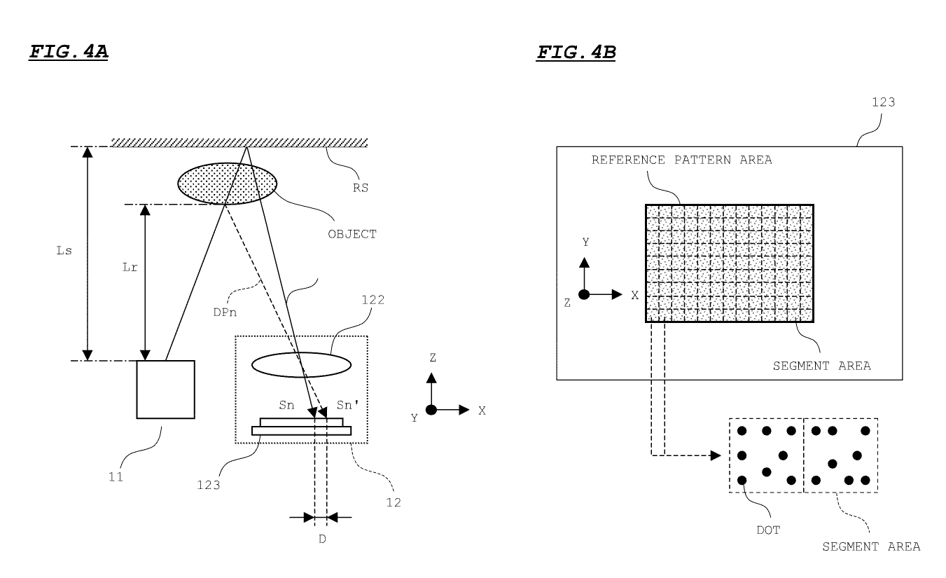

FIGS. 4A, 4B are diagrams schematically showing a reference template generation method for use in the aforementioned distance detection.

As shown in FIG. 4A, at the time of generating a reference template, a reflection plane RS perpendicular to Z-axis direction is disposed at a position away from the projection optical system 11 by a predetermined distance Ls. The temperature of the laser light source 111 is retained at a predetermined temperature (reference temperature). Then, DP light is emitted from the projection optical system 11 for a predetermined time Te in the above state. The emitted DP light is reflected on the reflection plane RS, and is entered to the CMOS image sensor 123 in the light receiving optical system 12. By performing the above operation, an electrical signal at each pixel is outputted from the CMOS image sensor 123. The value (pixel value) of the electrical signal at each outputted pixel is expanded in the memory 25 shown in FIG. 2.

As shown in FIG. 4B, a reference pattern area for defining an irradiation area of DP light on the CMOS image sensor 123 is set, based on the pixel values expanded in the memory 25. Further, the reference pattern area is divided into segment areas in the form of a matrix. As described above, dots locally appear with a unique pattern in each segment area. Accordingly, in the example shown in FIG. 4B, each segment area has a different pattern of pixel values. In the example shown in FIG. 4B, each one of the segment areas has the same size as all the other segment areas.

The reference template is configured in such a manner that pixel values of the pixels included in each segment area set on the CMOS image sensor 123 are correlated to the segment area.

Specifically, the reference template includes information relating to the position of a reference pattern area on the CMOS image sensor 123, pixel values of all the pixels included in the reference pattern area, and information for use in dividing the reference pattern area into segment areas. The pixel values of all the pixels included in the reference pattern area correspond to a dot pattern of DP light included in the reference pattern area. Further, pixel values of pixels included in each segment area are acquired by dividing a mapping area on pixel values of all the pixels included in the reference pattern area into segment areas. The reference template may retain pixel values of pixels included in each segment area, for each segment area.

The reference template thus configured is stored in the memory 25 shown in FIG. 2 in a non-erasable manner. The reference template stored in the memory 25 is referred to in calculating a distance from the projection optical system 11 to each portion of an object to be detected.

For instance, in the case where an object is located at a position nearer to the distance Ls shown in FIG. 4A, DP light (DPn) corresponding to a segment area Sn on the reference pattern is reflected on the object, and is entered to an area Sn′ different from the segment area Sn. Since the projection optical system 11 and the light receiving optical system 12 are adjacent to each other in X-axis direction, the displacement direction of the area Sn′ relative to the segment area Sn is aligned in parallel to X-axis. In the case shown in FIG. 4A, since the object is located at a position nearer to the distance Ls, the area Sn′ is displaced relative to the segment area Sn in plus X-axis direction. If the object is located at a position farther from the distance Ls, the area Sn′ is displaced relative to the segment area Sn in minus X-axis direction.

A distance Lr from the projection optical system 11 to a portion of the object irradiated with DP light (DPn) is calculated, using the distance Ls, and based on a displacement direction and a displacement amount of the area Sn′ relative to the segment area Sn, by a triangulation method. A distance from the projection optical system 11 to a portion of the object corresponding to the other segment area is calculated in the same manner as described above.

In performing the distance calculation, it is necessary to detect to which position, a segment area Sn of the reference template has displaced at the time of actual measurement. The detection is performed by performing a matching operation between a dot pattern of DP light irradiated onto the CMOS image sensor 123 at the time of actual measurement, and a dot pattern included in the segment area Sn.

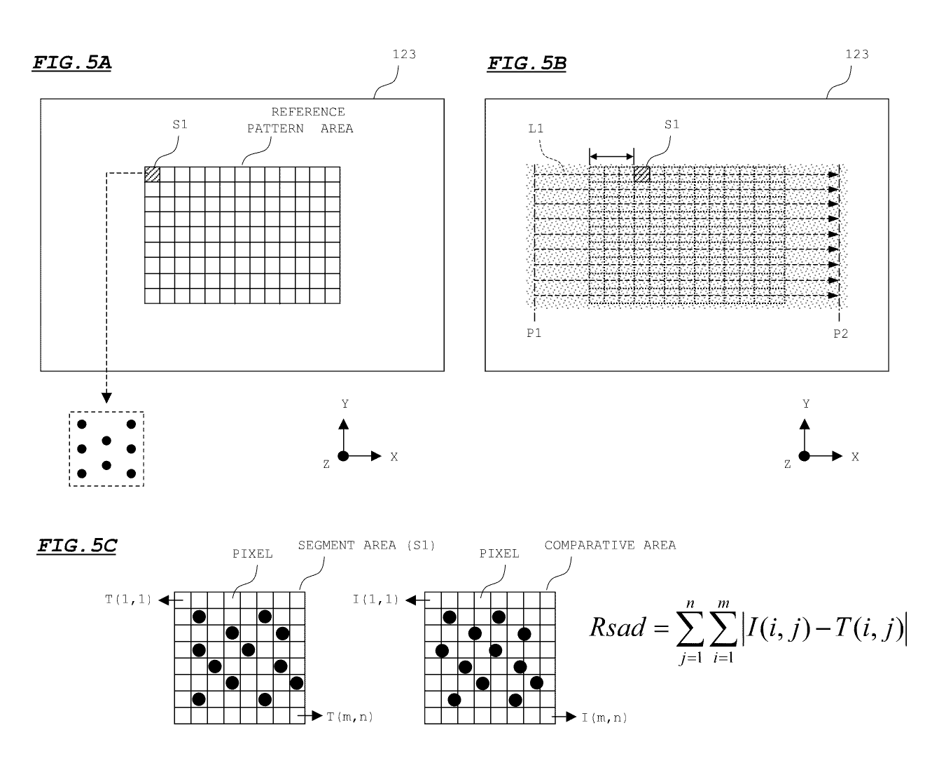

FIGS. 5A through 5C are diagrams for describing the aforementioned detection method. FIG. 5A is a diagram showing a state as to how a reference pattern area and a segment area are set on the CMOS image sensor 123, FIG. 5B is a diagram showing a segment area searching method to be performed at the time of actual measurement, and FIG. 5C is a diagram showing a matching method between an actually measured dot pattern of DP light, and a dot pattern included in a segment area of a reference template.

For instance, in the case where a displacement position of a segment area S1 at the time of actual measurement shown in FIG. 5A is searched, as shown in FIG. 5B, the segment area S1 is fed pixel by pixel in X-axis direction in a range from P1 to P2 for obtaining a matching degree between the dot pattern of the segment area S1, and the actually measured dot pattern of DP light, at each feeding position. In this case, the segment area S1 is fed in X-axis direction only on a line L1 passing an uppermost segment area group in the reference pattern area. This is because, as described above, each segment area is normally displaced only in X-axis direction from a position set by the reference template at the time of actual measurement. In other words, the segment area S1 is conceived to be on the uppermost line L1. By performing a searching operation only in X-axis direction as described above, the processing load for searching is reduced.

At the time of actual measurement, a segment area may be deviated in X-axis direction from the range of the reference pattern area, depending on the position of an object to be detected. In view of the above, the range from P1 to P2 is set wider than the X-axis directional width of the reference pattern area.

At the time of detecting the matching degree, an area (comparative area) of the same size as the segment area S1 is set on the line L1, and a degree of similarity between the comparative area and the segment area S1 is obtained. Specifically, there is obtained a difference between the pixel value of each pixel in the segment area S1, and the pixel value of a pixel, in the comparative area, corresponding to the pixel in the segment area S1. Then, a value Rsad which is obtained by summing up the difference with respect to all the pixels in the comparative area is acquired as a value representing the degree of similarity.

For instance, as shown in FIG. 5C, in the case where pixels of m columns by n rows are included in one segment area, there is obtained a difference between a pixel value T (i, j) of a pixel at i-th column, j-th row in the segment area, and a pixel value I (i, j) of a pixel at i-th column, j-th row in the comparative area. Then, a difference is obtained with respect to all the pixels in the segment area, and the value Rsad is obtained by summing up the differences. In other words, the value Rsad is calculated by the following formula.

$$Rsad = {\sum }_{j = 1}^{n} {\sum }_{i = 1}^{m} \vert I ( i , j ) - T ( i , j ) \vert$$

As the value Rsad is smaller, the degree of similarity between the segment area and the comparative area is high.

At the time of a searching operation, the comparative area is sequentially set in a state that the comparative area is displaced pixel by pixel on the line L1. Then, the value Rsad is obtained for all the comparative areas on the line L1. A value Rsad smaller than a threshold value is extracted from among the obtained values Rsad. In the case where there is no value Rsad smaller than the threshold value, it is determined that the searching operation of the segment area S1 has failed. In this case, a comparative area having a smallest value among the extracted values Rsad is determined to be the area to which the segment area S1 has moved. The segment areas other than the segment area S1 on the line L1 are searched in the same manner as described above. Likewise, segment areas on the other lines are searched in the same manner as described above by setting a comparative area on the other line.

In the case where the displacement position of each segment area is searched from the dot pattern of DP light acquired at the time of actual measurement in the aforementioned manner, as described above, the distance to a portion of the object to be detected corresponding to each segment area is obtained based on the displacement positions, using a triangulation method.

FIG. 6 is a perspective view showing an installation state of the projection optical system 11 and the light receiving optical system 12.

The projection optical system 11 and the light receiving optical system 12 are mounted on a base plate 300 having a high heat conductivity. The optical members constituting the projection optical system 11 are mounted on a chassis 11a. The chassis 11a is mounted on the base plate 300. With this arrangement, the projection optical system 11 is mounted on the base plate 300.

The light receiving optical system 12 is mounted on top surfaces of two base blocks 300a on the base plate 300, and on a top surface of the base plate 300 between the two base blocks 300a. The CMOS image sensor 123 to be described later is mounted on the top surface of the base plate 300 between the base blocks 300a. A holding plate 12a is mounted on the top surfaces of the base blocks 300a. A lens holder 12b for holding a filter 121 and an imaging lens 122 to be described later is mounted on the holding plate 12a.

The projection optical system 11 and the light receiving optical system 12 are aligned in X-axis direction away from each other with a predetermined distance in such a manner that the projection center of the projection optical system 11 and the imaging center of the light receiving optical system 12 are linearly aligned in parallel to X-axis. A circuit board 200 (see FIG. 7) for holding the circuit section (see FIG. 2) of the information acquiring device 1 is mounted on the back surface of the base plate 300.

A hole 300b is formed in the center of a lower portion of the base plate 300 for taking out a wiring of a laser light source 111 from a back portion of the base plate 300. Further, an opening 300c for exposing a connector 12c of the CMOS image sensor 123 from the back portion of the base plate 300 is formed in the position of the base plate 300 lower than the position where the light receiving optical system 12 is installed.

FIG. 7 is a diagram schematically showing an arrangement of the projection optical system 11 and the light receiving optical system 12 in the embodiment.

The projection optical system 11 is provided with the laser light source 111, a collimator lens 112, a rise-up mirror 113, and a DOE (Diffractive Optical Element) 114. Further, the light receiving optical system 12 is provided with the filter 121, the imaging lens 122, and the CMOS image sensor 123.

The laser light source 111 outputs laser light of a narrow wavelength band of or about 830 nm. The laser light source 111 is disposed in such a manner that the optical axis of laser light is aligned in parallel to X-axis. The collimator lens 112 converts the laser light emitted from the laser light source 111 into substantially parallel light. The collimator lens 112 is disposed in such a manner that the optical axis thereof is aligned with the optical axis of laser light emitted from the laser light source 111. The rise-up mirror 113 reflects laser light entered from the collimator lens 112 side. The optical axis of laser light is bent by 90° by the rise-up mirror 113 and is aligned in parallel to Z-axis.

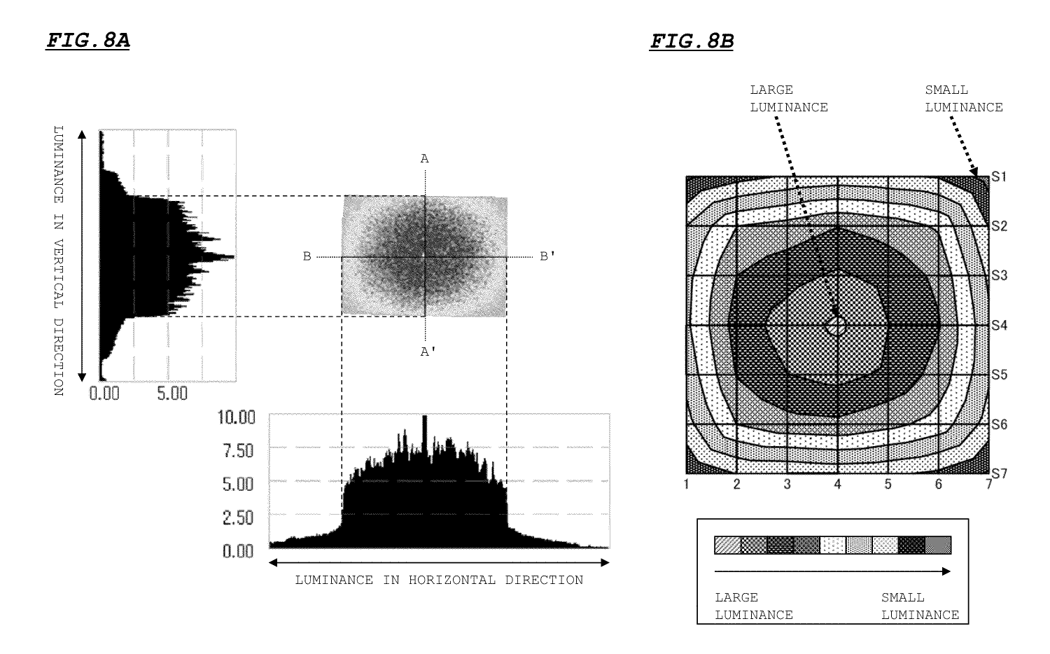

The DOE 114 has a diffraction pattern on a light incident surface thereof. The DOE 114 is formed by e.g. injection molding using resin, or by subjecting a glass substrate to lithography or dry-etching. The diffraction pattern is formed by e.g. step-type hologram. Laser light reflected on the rise-up mirror 113 and entered to the DOE 114 is converted into laser light having a dot pattern by a diffractive action of the diffraction pattern, and is irradiated onto a target area. The diffraction pattern is designed to have a predetermined dot pattern in a target area. The dot pattern in the target area will be described later referring to FIGS. 8A through 10B.

There is disposed an aperture (not shown) for forming the shape of laser light into a circular shape between the laser light source 111 and the collimator lens 112. The aperture may be formed by an emission opening of the laser light source 111.

Laser light reflected on the target area is entered to the imaging lens 122 through the filter 121.

The filter 121 transmits light of a wavelength band including the emission wavelength (of or about 830 nm) of the laser light source 111, and blocks light of the other wavelength band. The imaging lens 122 condenses light entered through the filter 121 on the CMOS image sensor 123. The imaging lens 122 is constituted of plural lenses, and an aperture and a spacer are interposed between a lens and another lens of the imaging lens 122. The aperture converges external light to be in conformity with the F-number of the imaging lens 122.

The CMOS image sensor 123 receives light condensed on the imaging lens 122, and outputs a signal (electric charge) in accordance with a received light amount to the image signal processing circuit 23 pixel by pixel. In this example, the CMOS image sensor 123 is configured to perform high-speed signal output so that a signal (electric charge) of each pixel can be outputted to the image signal processing circuit 23 with a high response from a light receiving timing at each of the pixels.

The filter 121 is disposed in such a manner that the light receiving surface thereof extends perpendicular to Z-axis. The imaging lens 122 is disposed in such a manner that the optical axis thereof extends in parallel to Z-axis. The CMOS image sensor 123 is disposed in such a manner that the light receiving surface thereof extends perpendicular to Z-axis. Further, the filter 121, the imaging lens 122 and the CMOS image sensor 123 are disposed in such a manner that the center of the filter 121 and the center of the light receiving area of the CMOS image sensor 123 are aligned on the optical axis of the imaging lens 122.

As described above referring to FIG. 6, the projection optical system 11 and the light receiving optical system 12 are mounted on the base plate 300. Further, the circuit board 200 is mounted on the lower surface of the base plate 300, and wirings (flexible substrates) 201 and 202 are connected from the circuit board 200 to the laser light source 111 and to the CMOS image sensor 123. The circuit section of the information acquiring device 1 such as the CPU 21 and the laser driving circuit 22 shown in FIG. 2 is mounted on the circuit board 200.

In the arrangement shown in FIG. 7, the DOE 114 is normally designed in such a manner that dots of a dot pattern are uniformly distributed with the same luminance in a target area. By distributing the dots in the aforementioned manner, it is possible to search a target area uniformly. As a result of actually generating a dot pattern using the thus designed DOE 114, however, it has been found that the luminance of dots varies depending on the areas. Further, it has been found that the luminance variation among the dots has a certain tendency. The following is a description about an analysis and an evaluation of the DOE 114 conducted by the inventor of the present application.

Firstly, as a comparative example, the inventor of the present application adjusted a diffraction pattern of a DOE 114 in such a manner that dots of a dot pattern were uniformly distributed with the same luminance in a target area. Subsequently, the inventor of the present application actually projected light having a dot pattern onto a target area, using the DOE 114 constructed according to the aforementioned design, and captured a projection state of the dot pattern at the time of projection by the CMOS image sensor 123. Then, the inventor measured a luminance distribution of the dot pattern on the CMOS image sensor 123, based on a received light amount (detection signal) of each pixel on the CMOS image sensor 123.

FIG. 8A shows a measurement result about a luminance distribution on the CMOS image sensor 123, in the case where the DOE 114 as the comparative example is used. In the center portion of FIG. 8A, there is illustrated a luminance distribution diagram showing luminances on the light receiving surface (two-dimensional plane) of the CMOS image sensor 123 in colors (in FIG. 8A, a luminance variation is expressed by color difference). In the left portion of FIG. 8A and the lower portion of FIG. 8A, there are illustrated graphs respectively showing luminance values taken along the line A-A′ and the line B-B′ of the luminance distribution diagram. The left-side graph and the lower-side graph are respectively normalized by setting a maximum luminance to 10. As shown in the left-side graph and the lower-side graph of FIG. 8A, actually, there exist luminances in a region in the periphery of the diagram shown in the center portion of FIG. 8A. However, since the luminances in the region are low, to simplify the description, the diagram shown in the center portion of FIG. 8A does not show the luminances in the region.

FIG. 8B is a diagram schematically showing the luminance distribution shown in FIG. 8A. In FIG. 8B, the magnitude of luminance on the CMOS image sensor 123 is displayed in nine stages. It is clear that the luminance lowers as the position of the dot is shifted from a center portion toward a peripheral portion of the CMOS image sensor 123.

As shown in FIGS. 8A and 8B, the luminance on the CMOS image sensor 123 is maximum in the center of the CMOS image sensor 123, and the luminance lowers as the position of the dot is shifted away from the center. As described above, even in the case where the DOE 114 is designed to uniformly distribute the dots of a dot pattern with the same luminance in a target area, actually, the luminance varies on the CMOS image sensor 123. Specifically, the above measurement result shows that the dot pattern projected onto a target area has a tendency that the luminance of dots lowers, as the position of the dot is shifted from a center portion toward a peripheral portion of the CMOS image sensor 123.

Referring to FIGS. 8A and 8B, it is clear that the luminance of dots radially changes from the center of the CMOS image sensor 123. In other words, it is conceived that dots having substantially the same luminance are distributed substantially concentrically with respect to the center of a dot pattern, and the luminance of dots gradually lowers as the position of the dot is shifted away from the center. The inventor of the present application conducted the same measurement as described above for plural DOEs 114 that have been designed in the same manner as described above. As a result of the measurement, the same tendency was confirmed for any one of the DOEs 114. Accordingly, it is conceived that in the case where a DOE 114 is designed in such a manner that dots of a dot pattern are uniformly distributed with the same luminance in a target area, generally, the dots to be projected onto the target area are distributed with the aforementioned tendency.

If the luminance varies as described above, dots are less likely to be detected in the peripheral portion where the luminance is low, resulting from stray light such as natural light or light from an illuminator, although the number of dots to be included in a segment area is substantially the same between the center portion and the peripheral portion of the CMOS image sensor 123. Thus, the precision in pattern matching may be degraded in a segment area in the peripheral portion of the CMOS image sensor 123.

In the case where the luminance in the peripheral portion lowers as described above, for instance, it is proposed to set the gain of a detection signal in the peripheral portion of the CMOS image sensor 123 to a large value for the purpose of increasing the detection signal based on dots in the peripheral portion. Even if the gain in the peripheral portion is set to a large value as described above, it is difficult to properly detect dots in the peripheral portion where the luminance is low, because the detection signal based on stray light may also increase.

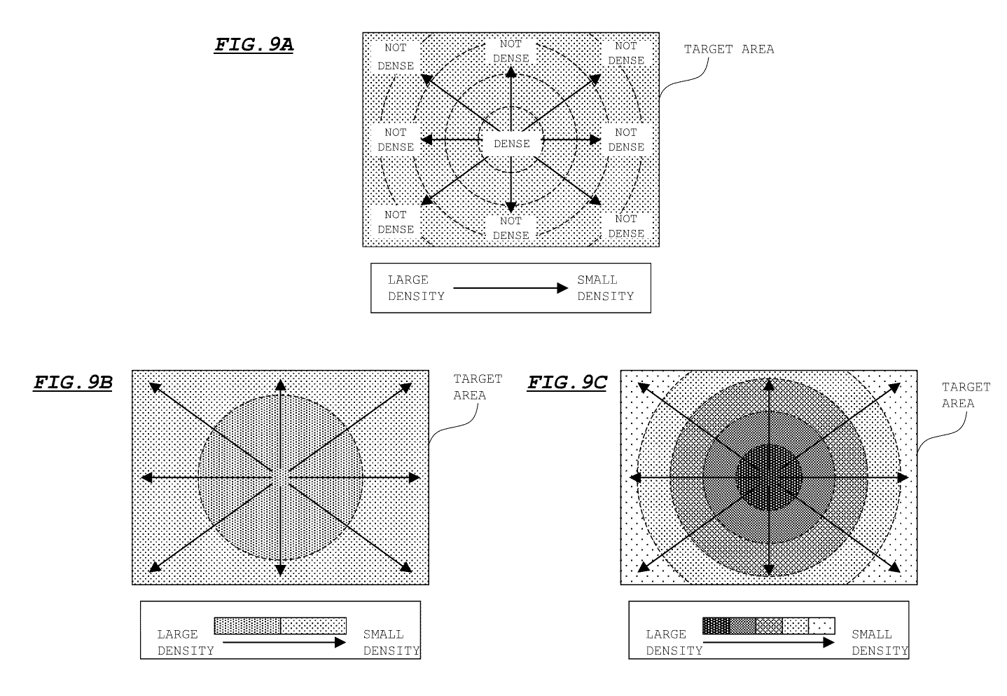

In view of the above, in the embodiment, as shown in FIG. 9A, the diffraction pattern of the DOE 114 is adjusted in such a manner that a dot pattern is non-uniformly distributed in a target area.

FIG. 9A is a diagram schematically showing a dot distribution state in a target area in the embodiment. As shown in FIG. 9A, the DOE 114 in the embodiment is formed in such a manner that the density of dots decreases as the position of the dot is shifted concentrically away from the center in a target area (namely, in proportion to a distance from the center) by a diffractive action of the DOE 114. Each portion shown by a broken line in FIG. 9A represents a region where the density of dots is substantially equal to each other.

The density of dots may be linearly decreased or stepwise decreased, as the position of the dot is shifted radially away from the center of the dot pattern. For instance, in the case where the density of dots is stepwise decreased, as shown in FIGS. 9B and 9C, plural regions are concentrically set from the center of a dot pattern, and the density of dots within each region is made equal to each other. In FIGS. 9B and 9C, a region where the density of dots is equal to each other is indicated with the same gradation.

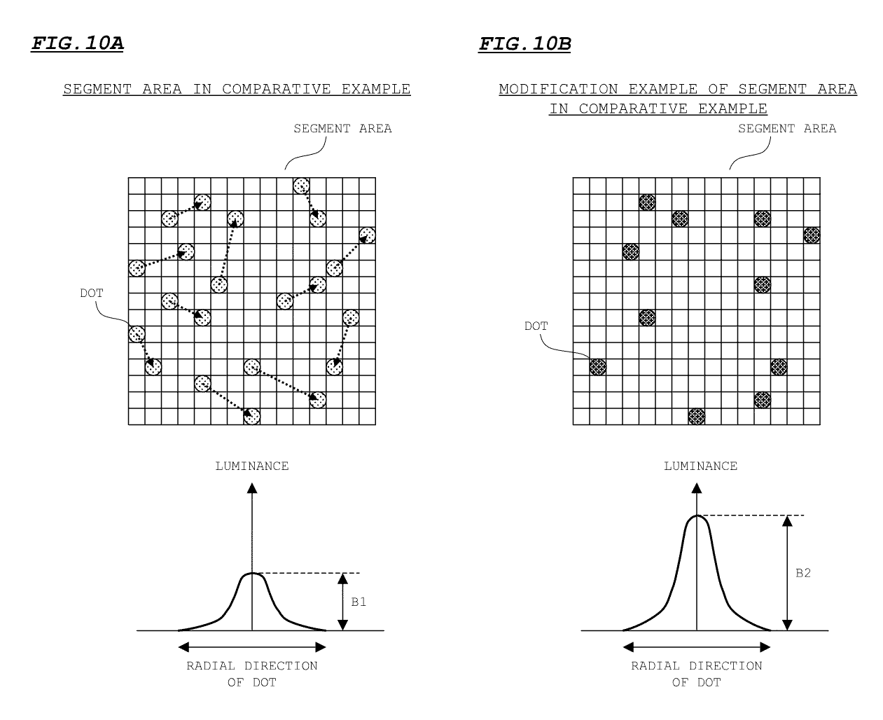

In this example, the density of dots is set small by gathering a certain number of dots to a certain position. For instance, as shown in FIG. 10A, in a comparative example, let it be assumed that one segment area (15 pixels by 15 pixels) includes twenty-two dots. In this example, let it be assumed that the luminance of individual dots in a segment area in a peripheral portion of the dot pattern is the luminance B1 which is schematically shown in the lower diagram of FIG. 10A. The design of the DOE 114 is adjusted in such a manner that eleven dots are guided from the above state to e.g. such positions that the eleven dots each overlap the remaining eleven dots, as shown by the dotted-line arrows in FIG. 10A. By performing the above operation, as shown in FIG. 10B, eleven dots are included in one segment area. Thus, the density of dots is reduced to ½ of the density of dots in the comparative example. In the above arrangement, since each dot in FIG. 10B is a dot obtained by overlapping two dots in the comparative example, as schematically shown in the lower diagram of FIG. 10B, the luminance of each dot in FIG. 10B is the luminance B2, which is about two times as high as the luminance of each dot in the comparative example. Thus, the luminance is increased while reducing the density of dots. The aforementioned dot overlapping is not performed in the center portion of the dot pattern. Accordingly, the density of dots and the luminance of dots in the center portion of the dot pattern are retained unchanged, as compared with the arrangement of the comparative example.

In the example shown in FIGS. 10A and 10B, dots in one segment area overlap each other. Actually, however, dots overlap each other for reducing the density of dots in such a manner that the dot pattern included in each segment area has a unique pattern. In other words, dots which overlap each other are not necessarily included in one segment area. Thus, the diffraction pattern of the DOE 114 is adjusted in such a manner that the dot pattern of each segment area becomes a unique pattern, and that the density of dots in a peripheral portion of the dot pattern decreases.

As described above, a decrease in the density of dots in a peripheral portion increases the luminance of dots in the peripheral portion. Accordingly, the dots in the peripheral portion are less likely to merge into stray light. However, since the number of dots to be included in a segment area in the peripheral portion decreases, as compared with the number of dots to be included in a segment area in the center portion, the precision in pattern matching for a segment area in the peripheral portion may be degraded.

In view of the above, in the embodiment, the diffraction pattern of the DOE 114 is adjusted as shown in FIG. 9A, and a segment area in the peripheral portion is set larger than a segment area in the center portion.

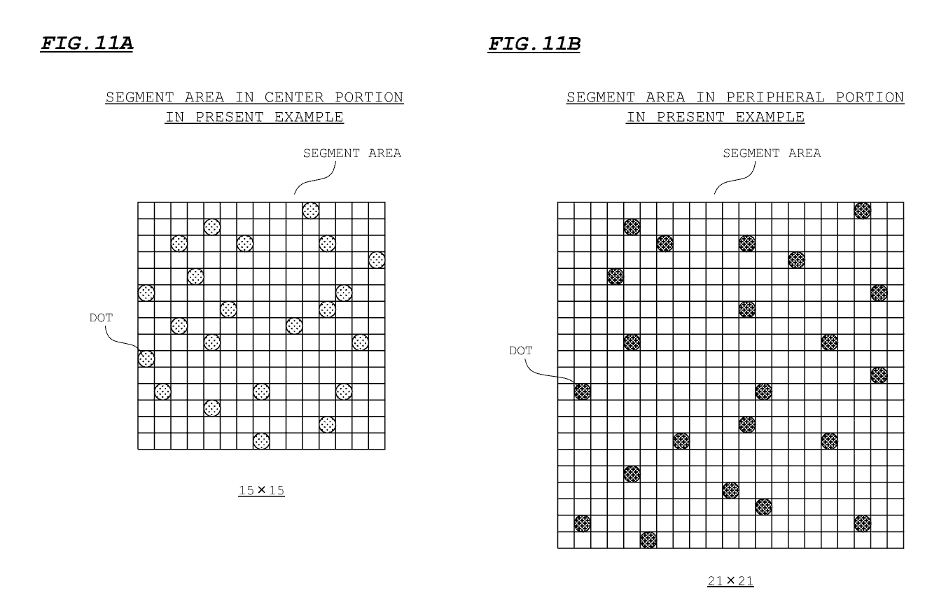

FIGS. 11A and 11B are diagrams respectively showing a segment area in a center portion and a segment area in a peripheral portion in the embodiment. In the embodiment, the density of dots in the peripheral portion is also set to ½ of the density of dots in the center portion, as well as in the arrangements shown in FIGS. 10A and 10B.

As shown in FIG. 11A, similarly to the arrangement shown in FIG. 10A, in the embodiment, the number of pixels in a segment area in the center portion is set to 15 pixels by 15 pixels, and twenty-two dots are included in one segment area. Further, as shown in FIG. 11B, in the embodiment, the number of pixels in a segment area in the peripheral portion is set to 21 pixels by 21 pixels. Since the density of dots in the peripheral portion is set to ½ of the density of dots in the center portion, in this example, one side of a segment area in the peripheral portion is set to the length corresponding to e.g. 21 pixels so that the surface area of a segment area in the peripheral portion is about two times as large as the surface area of a segment area in the center portion. By the above setting, the number of pixels to be included in a segment area in the peripheral portion is about two times as large as the number of pixels to be included in a segment area in the center portion. With this arrangement, the number of dots (twenty-two dots) to be included in a segment area in the peripheral portion is equal to the number of dots (twenty-two dots) to be included in a segment area in the center portion.

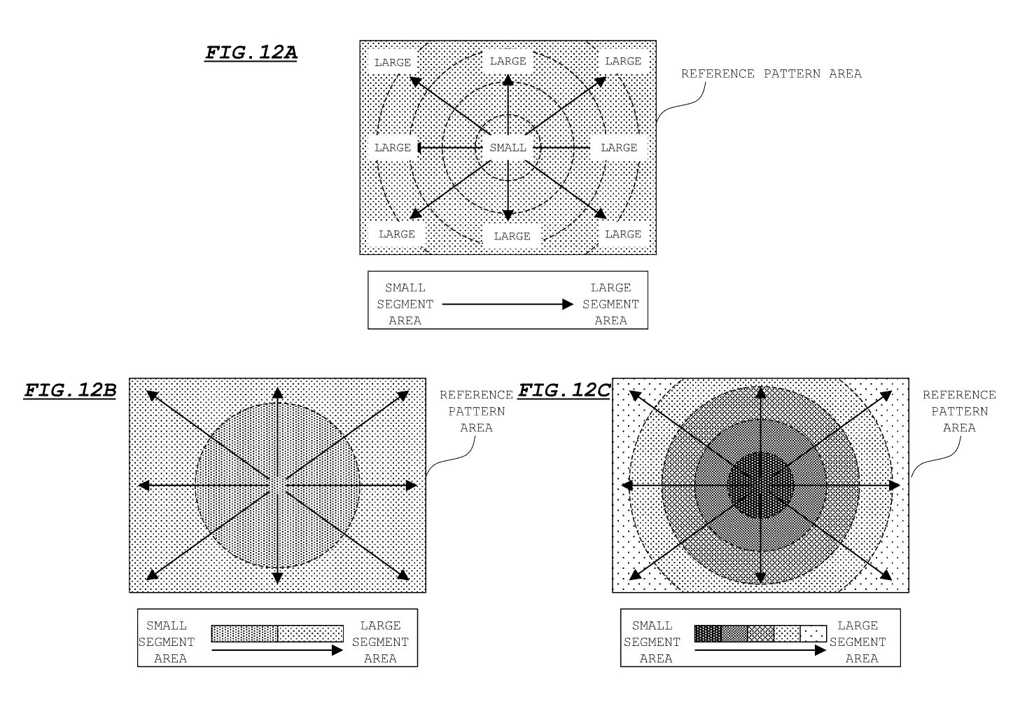

As described above, the dimensions of a segment area is appropriately set depending on a difference in the density of dots with respect to a center portion. For instance, as shown in FIG. 9A, in the case where the density of dots linearly decreases in accordance with a distance from the center portion, as shown in FIG. 12A, the dimensions of a segment area is set to change in accordance with the density of dots on a reference pattern area. Further, as shown in FIGS. 9B and 9C, in the case where the density of dots stepwise decreases in accordance with a distance from the center portion, as shown in FIGS. 12B and 12C, the dimensions of a segment area is set to stepwise change in accordance with the density of dots on the reference pattern area, respectively.

In the embodiment, information relating to the position of the reference pattern area on the CMOS image sensor 123, pixel values of all the pixels to be included in the reference pattern area, information relating to the height and width of a segment area, and information relating to the position of a segment area serve as a reference template. The reference template in the embodiment is also held in the memory 25 shown in FIG. 2 in a non-erasable manner. The reference template held in the memory 25 as described above is referred to by the CPU 21 in calculating a distance from the projection optical system 11 to each portion of an object to be detected.

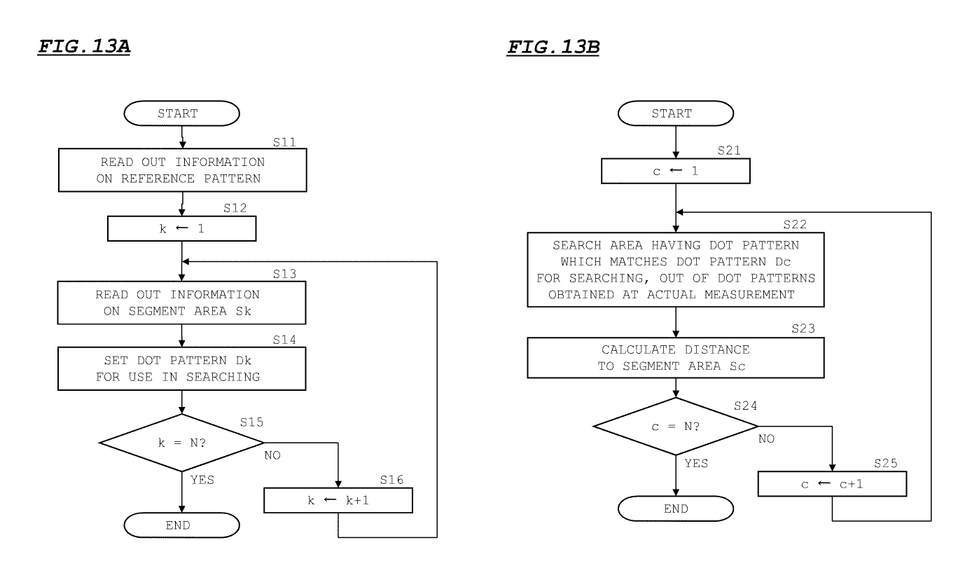

FIG. 13A is a flowchart showing a dot pattern setting processing with respect to a segment area. The processing is performed when the information acquiring device 1 is activated, or when distance detection is started. The reference template includes information for use in allocating individual segment areas whose dimensions are adjusted as described above, to the reference pattern area (see FIG. 4B). Specifically, the reference template includes information indicating the position of each segment area on the reference pattern area, and information indicating the dimensions (height and width) of each segment area. In this example, N segment areas whose dimensions are adjusted are assigned with respect to the reference pattern area, and the serial numbers from 1 to N are assigned to the segment areas.

Firstly, the CPU 21 of the information acquiring device 1 reads out, from the reference template held in the memory 25, the information relating to the position of the reference pattern area on the CMOS image sensor 123, and the pixel values of all the pixels to be included in the reference pattern area (S11). Then, the CPU 11 sets “1” to the variable k (S12).

Then, the CPU 21 acquires, from the reference template held in the memory 25, the information relating to the height and width of a k-th segment area Sk, and the information relating to the position of the segment area Sk (S13). Then, the CPU 21 sets a dot pattern Dk for use in searching, based on the pixel values of all the pixels to be included in the reference pattern area, and the information relating to the segment area Sk that has been acquired in S13 (S14). Specifically, the CPU 21 acquires the pixel values of a dot pattern to be included in the segment area Sk, out of the pixel values of all the pixels in the reference pattern area, and sets the acquired pixel values as the dot pattern Dk for use in searching.

Then, the CPU 21 determines whether the value of k is equal to N (S15). In the case where the dot pattern for use in searching is set with respect to all the segment areas, and the value of k is equal to N (S15: YES), the processing is terminated. On the other hand, in the case where the value of k is smaller than N (S15: NO), the CPU 21 increments the value of k by one (S16), and returns the processing to S13. In this way, N dot patterns for use in searching are sequentially set.

FIG. 13B is a flowchart showing a distance detection processing to be performed at the time of actual measurement. The distance detection processing is performed, using the dot pattern for use in searching, which has been set by the processing shown in FIG. 13A, and is concurrently performed with the processing shown in FIG. 13A.

Firstly, the CPU 21 of the information acquiring device 1 sets “1” to the variable c (S21). Then, the CPU 21 searches an area having a dot pattern which matches a c-th dot pattern Dc for use in searching, which has been set in S14 in FIG. 13A, out of the dot patterns on the CMOS image sensor 123 obtained by receiving light at the time of actual measurement (S22). The searching operation is performed for an area having a predetermined width in left and right directions (X-axis direction) with respect to a position corresponding to the segment area Sc. If there is an area having a dot pattern which matches the dot pattern Dc for use in searching, the CPU 21 detects a moving distance and a moving direction (right direction or left direction) of the area having the matched dot pattern, with respect to the position of the segment area Sc, and calculates a distance of an object located in the segment area Sc, using the detected moving direction and moving distance, based on a triangulation method (S23).

Then, the CPU 21 determines whether the value of c is equal to N (S24). Distance calculation is performed for all the segment areas, and if the value of c is equal to N (S24: YES), the processing is terminated. On the other hand, if the value of c is smaller than N (S24: NO), the CPU 21 increments the value of c by one (S25), and returns the processing to S22. In this way, a distance to an object to be detected, which corresponds to a segment area, is obtained.

As described above, in the embodiment, as shown in FIGS. 9A through 9C, the density of dots in a peripheral portion of a dot pattern is set smaller than the density of dots in a center portion of the dot pattern. With this arrangement, the luminance per dot in the peripheral portion increases, each dot is less likely to merge into stray light, and the position of each dot can be easily detected. Further, in the case where the density of dots is changed between a center portion and a peripheral portion as described above, as shown in FIGS. 12A through 12C, a segment area in the peripheral portion is set larger than a segment area in the center portion. With this arrangement, the number of dots to be included in a segment area increases when a pattern matching operation is performed for a segment area in the peripheral portion of a target area. Accordingly, it is possible to enhance the precision in pattern matching. As described above, in the embodiment, it is possible to suppress lowering of distance detection precision in a peripheral portion of a dot pattern by adjusting the density (luminance) of a dot pattern and the dimensions of a segment area.

The embodiment of the invention has been described as above. The invention is not limited to the foregoing embodiment, and the embodiment of the invention may be changed or modified in various ways other than the above.

For instance, in the embodiment, the CMOS image sensor 123 is used as a photodetector. Alternatively, a CCD image sensor may be used in place of the CMOS image sensor.

Further, in the embodiment, the laser light source 111 and the collimator lens 112 are aligned in X-axis direction, and the rise-up mirror 113 is formed to bend the optical axis of laser light in Z-axis direction. Alternatively, the laser light source 111 may be disposed in such a manner as to emit laser light in Z-axis direction; and the laser light source 111, the collimator lens 112, and the DOE 114 are aligned in Z-axis direction. In the modification, although the rise-up mirror 113 can be omitted, the size of the projection optical system 11 increases in Z-axis direction.

Further, in the embodiment, as shown in FIGS. 11A and 11B, the diffraction pattern of the DOE 114 is adjusted in such a manner that the density of dots in a peripheral portion of a dot pattern is set to ½ of the density of dots in a center portion of the dot pattern. However, the manner to set the density of the dots is not limited to this manner. Alternatively, the density of dots in a peripheral portion of a dot pattern may be set in such a manner that the luminance of dots in the peripheral portion increases.

Further, in the embodiment, as shown in FIGS. 11A and 11B, the pixel number in one segment area is set in such a manner that the pixel number is 15 pixels by 15 pixels in a center portion and the pixel number is 21 pixels by 21 pixels in a peripheral portion. Alternatively, the pixel number may be the number other than the above, as far as the number of pixels to be included in a segment area in a peripheral portion is larger than the number of pixels to be included in a segment area in a center portion.

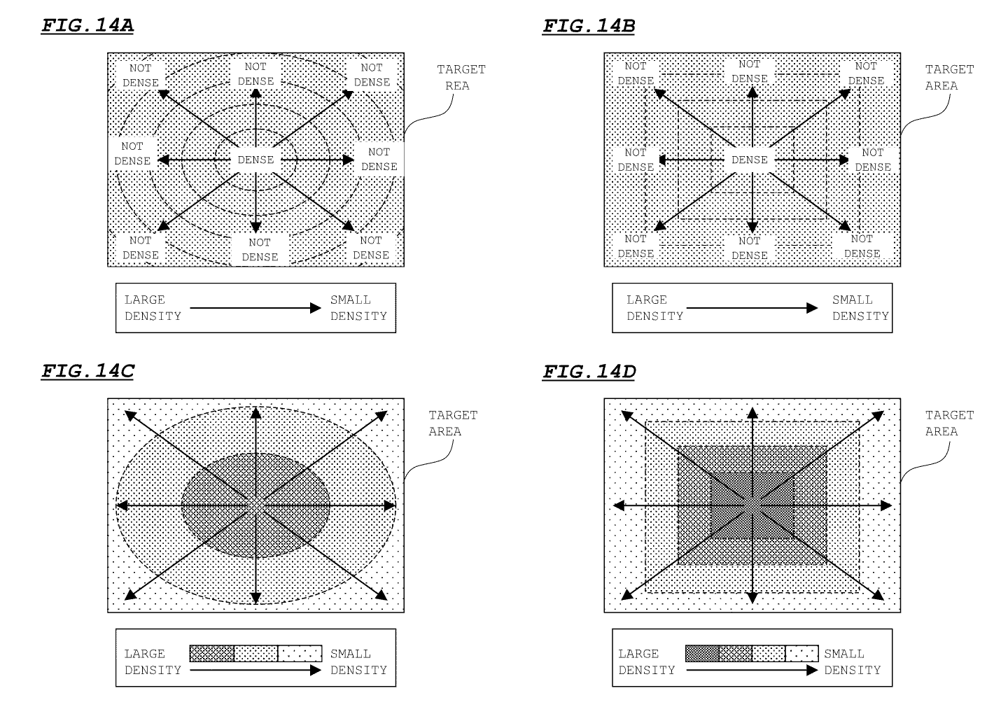

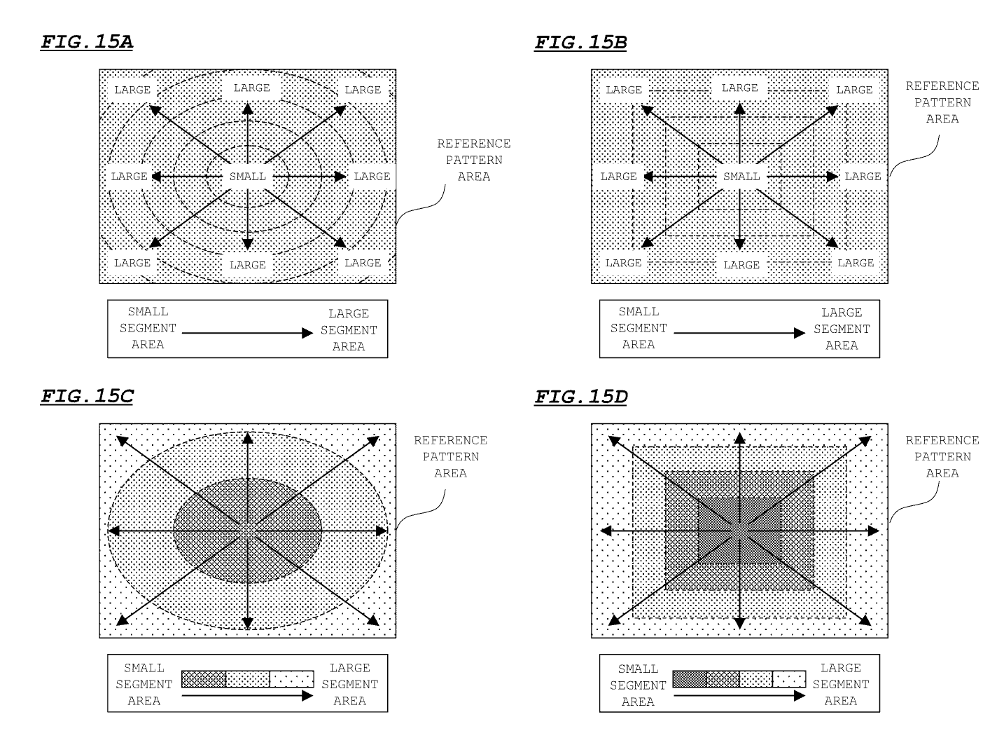

Further, in the embodiment, as shown in FIGS. 9A through 9C, the density of dots in a target area is configured to decrease, as the position of the dot is shifted concentrically away from the center. Alternatively, as shown in FIGS. 14A and 14B, the density of dots in a target area may be configured to linearly decrease, as the position of the dot is shifted elliptically and rectangularly away from the center. In the modification, as shown in FIGS. 14C and 14D, the density of dots may be configured to stepwise decrease, as the position of the dot is shifted radially away from the center of a dot pattern. In the case where the density of dots is set as shown in FIGS. 14A through 14D, the dimensions of a segment area is set in accordance with the density of dots, as shown in FIGS. 15A through 15D.

Further, in the embodiment, segment areas are set by dividing a reference pattern area in the form of a matrix. Alternatively, segment areas may be set in such a manner that segment areas adjacent to each other in left and right directions may overlap each other, or segment areas adjacent to each other in up and down directions may overlap each other. In the modification, as described above, each segment area is set in such a manner that a segment area in a peripheral portion of a dot pattern is larger than a segment area in a center portion of the dot pattern.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a projection optical system which projects laser light onto the target area with a predetermined dot pattern;
a light receiving optical system which is aligned with the projection optical system away from the projection optical system by a predetermined distance, and captures an image of the target area; and
a distance acquiring section which acquires a distance to each portion of an object in the target area, based on the dot pattern captured by the light receiving optical system, wherein
the projection optical system is configured in such a manner that a density of dots in a peripheral portion of the dot pattern is smaller than a density of dots in a center portion of the dot pattern in the target area,
the distance acquiring section sets segment areas onto a reference dot pattern reflected on a reference plane and captured by the light receiving optical system, and performs a matching operation between a captured dot pattern obtained by capturing the image of the target area at a time of distance measurement, and dots in each segment area to thereby acquire a distance to the each segment area, and
the segment areas are set in such a manner that a segment area in a peripheral portion of the reference dot pattern is larger than a segment area in a center portion of the reference dot pattern.

2. The information acquiring device according to claim 1, wherein
the projection optical system is configured in such a manner that the density of the dots on the reference plane decreases in accordance with a distance from a center of the reference dot pattern, and
the segment areas are configured in such a manner that a segment area increases in accordance with the distance from the center of the reference dot pattern.

3. The information acquiring device according to claim 2, wherein
the projection optical system is configured in such a manner that the density of the dots on the reference plane stepwise decreases, as the position of the dot is shifted radially away from the center of the reference dot pattern, and
the segment areas are configured in such a manner that a segment area stepwise increases, as the position of the segment area is shifted radially away from the center of the reference dot pattern.

4. The information acquiring device according to claim 1, wherein
the projection optical system is configured in such a manner that a luminance of the dots in the peripheral portion of the reference dot pattern is set higher than a luminance of the dots in the center portion of the reference dot pattern on the reference plane.

5. The information acquiring device according to claim 1, wherein
the projection optical system includes:
a laser light source;
a collimator lens to which laser light emitted from the laser light source is entered; and
a diffractive optical element which converts the laser light transmitted through the collimator lens into light having a dot pattern by diffraction, and
the light receiving optical system includes:
an image sensor;
a condensing lens which condenses the laser light from the target area on the image sensor; and
a filter which extracts light of a wavelength band of the laser light for guiding the light to the image sensor.

6. An object detecting device, comprising:
an information acquiring device which acquires information on a target area using light,
the information acquiring device including:
a projection optical system which projects laser light onto the target area with a predetermined dot pattern;
a light receiving optical system which is aligned with the projection optical system away from the projection optical system by a predetermined distance, and captures an image of the target area; and
a distance acquiring section which acquires a distance to each portion of an object in the target area, based on the dot pattern captured by the light receiving optical system, wherein
the projection optical system is configured in such a manner that a density of dots in a peripheral portion of the dot pattern is smaller than a density of dots in a center portion of the dot pattern in the target area,
the distance acquiring section sets segment areas onto a reference dot pattern reflected on a reference plane and captured by the light receiving optical system, and performs a matching operation between a captured dot pattern obtained by capturing the image of the target area at a time of distance measurement, and dots in each segment area to thereby acquire a distance to the each segment area, and
the segment areas are set in such a manner that a segment area in a peripheral portion of the reference dot pattern is larger than a segment area in a center portion of the reference dot pattern.

7. The object detecting device according to claim 6, wherein
the projection optical system is configured in such a manner that the density of the dots on the reference plane decreases in accordance with a distance from a center of the reference dot pattern, and
the segment areas are configured in such a manner that a segment area increases in accordance with the distance from the center of the reference dot pattern.

8. The object detecting device according to claim 7, wherein
the projection optical system is configured in such a manner that the density of the dots on the reference plane stepwise decreases, as the position of the dot is shifted radially away from the center of the reference dot pattern, and
the segment areas are configured in such a manner that a segment area stepwise increases, as the position of the segment area is shifted radially away from the center of the reference dot pattern.

9. The object detecting device according to claim 6, wherein
the projection optical system is configured in such a manner that a luminance of the dots in the peripheral portion of the reference dot pattern is set higher than a luminance of the dots in the center portion of the reference dot pattern on the reference plane.

10. The object detecting device according to claim 6, wherein
the projection optical system includes:
a laser light source;
a collimator lens to which laser light emitted from the laser light source is entered; and
a diffractive optical element which converts the laser light transmitted through the collimator lens into light having a dot pattern by diffraction, and
the light receiving optical system includes:
an image sensor;
a condensing lens which condenses the laser light from the target area on the image sensor; and
a filter which extracts light of a wavelength band of the laser light for guiding the light to the image sensor.
